(19) United States
(12) Patent Application Publication
(10) Pub. No.: US 2015/0060569 A1
(43) Pub. Date: Mar. 5, 2015

(54) SPRAY GUN

(71) Applicant: Pin-Hsien YU, Taipei City (TW)

(72) Inventor: Pin-Hsien YU, Taipei City (TW)

(73) Assignee: AQUALEAN MANUFACTURING ASSOCIATES CO., LTD., Taipei City (TW)

(21) Appl. No.: 14/456,466

(22) Filed: Aug. 11, 2014

(30) Foreign Application Priority Data
Sep. 4, 2013 (TW) 102216598

(51) Int. Cl. B05B 1/12; B05B 9/01

(52) U.S. Cl. CPC B05B 1/12; B05B 9/01
USPC 239/393

(57) ABSTRACT

A spray gun includes a handle and a spray head mounted to each other for forming a hollow main body. A switching assembly is mounted in the main body between the handle and the spray head for controlling the operating type of the spray gun. The switching assembly includes a seat mounted in the main body, a shank extending through the seat, an outlet set received in the seat, a first button and a second button, wherein the first button and the second button are respectively connected two a front end and a rear end of the shank.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a spray gun, and more particularly to a spray gun that includes a switching assembly mounted therein for easy operation.

2. Description of Related Art Including Information Disclosed under 37 CFR 1.97 and 37 CFR 1.98

A spray gun is usually used for gardening and spraying water on flowers and plants. A conventional spray gun is connected to a water source and sprays various sprays by a spray head thereof.

A conventional spray gun in accordance with the prior art includes a handle and a spray head mounted to each other. A trigger is mounted on the handle such that the water is sprayed when the trigger is pressed. The type of conventional gun has been widely used for several years. The user's palm may be numb after operating the conventional spray gun for a period of time because the trigger must be continually pressed during spraying of water. As a result, the convenience, the comfort and the smoothness of the conventional spray gun are weak such that the conventional spray gun needs to be advantageously altered.

The present invention has arisen to mitigate and/or obviate the disadvantages of the conventional spray gun.

### BRIEF SUMMARY OF THE INVENTION

The main objective of the present invention is to provide an improved spray gun that can be easily and comfortably operated.

To achieve the objective, the spray gun in accordance with the present invention comprises a main body including a handle and a spray head mounted to each other, wherein the handle and the spray are hollow structures such that a passage is defined in the main body. A T-shaped receiving portion is defined in a top portion of the handle and an opening is defined in a bottom of the receiving portion, wherein the opening communicates with the passage. The handle has a lower end adapted to be connected to a water source to allow the water flowing into the passage. A switching assembly is mounted in the main body between the handle and the spray head for controlling the operating type of the spray gun. The switching assembly comprises a seat mounted in the main body and partially received in the receiving portion in the handle. The seat has a through hole defined therein and communicating with the passage in the main body. Two tubes respectively extend from the seat and each tube has a tunnel defined therein, wherein the two tunnels linearly correspond to each other and communicates with the through hole in the seat. A shank extends through the seat via the two tunnels and is reciprocally movable relative to the seat. A first through hole is diametrically defined in the shank and selectively communicates with the through hole. A first button and a second button are respectively mounted onto a front end and a rear end of the shank. The first button and the second button alternately extend out of the main body for user to easily controlling the operating type of the spray gun.

Further benefits and advantages of the present invention will become apparent after a careful reading of the detailed description with appropriate reference to the accompanying drawings.

### BRIEF DESCRIPTION OF THE SEVERAL VIEWS OF THE DRAWINGS

FIG. 1 is an exploded perspective view of a spray gun in accordance with the present invention.

FIG. 2 is a perspective view of a spray gun in accordance with the present invention.

FIG. 3 is a side plan view of the spray gun in FIG. 2.

FIG. 4 is a cross-sectional operational view of the spray gun in FIG. 2 when spraying.

FIG. 5 is a cross-sectional operational view of the spray gun in FIG. 2 when the passage in the spray gun is closed.

### DETAILED DESCRIPTION OF THE INVENTION

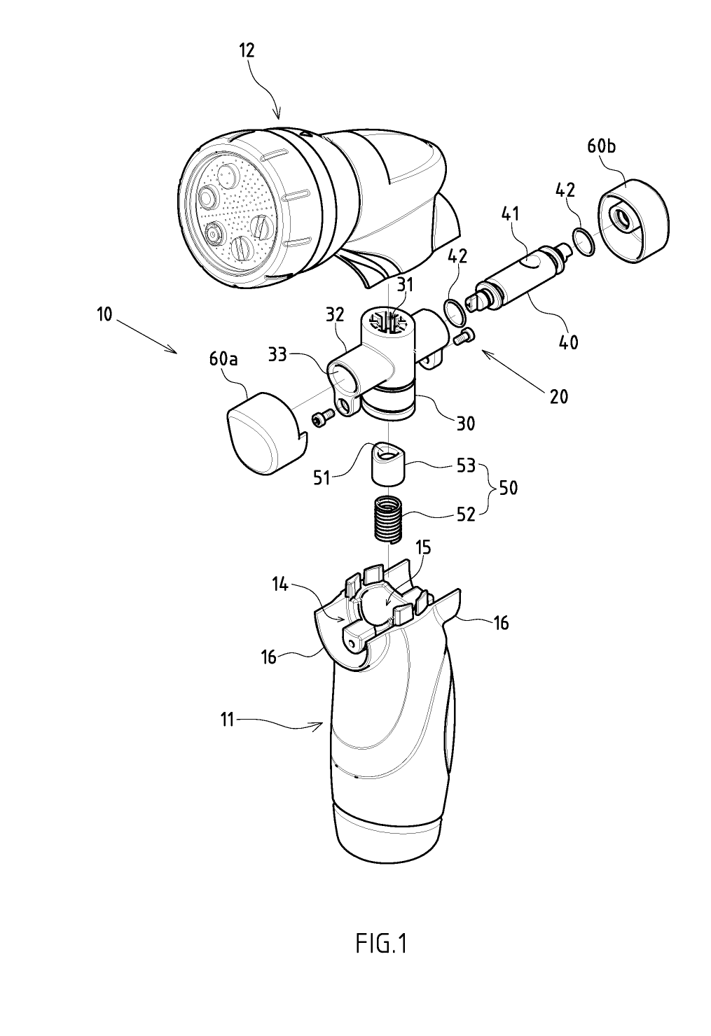

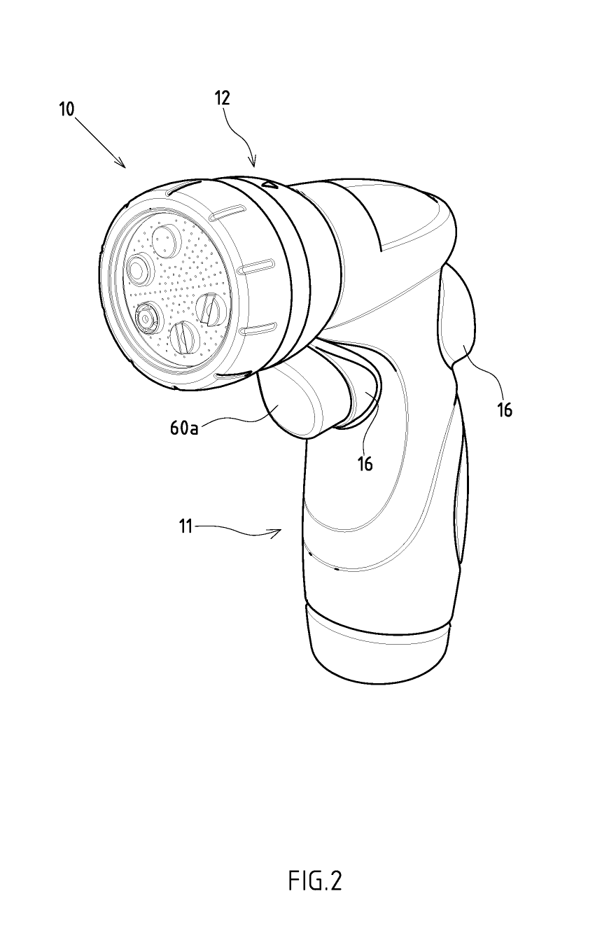

With reference to FIGS. 1, 2 and 3, the spray gun in accordance with the present invention comprises a main body 10 including a handle 11 and a spray head 12 mounted to each other, wherein the spray head 12 can provide various spray types. The handle 11 and the spray 12 are hollow structures such that a passage 13 is defined in the main body 10. A T-shaped receiving portion 14 is defined in a top portion of the handle 11 and an opening 15 is defined in a bottom of the receiving portion 14, wherein the opening 15 communicates with the passage 13. The handle 11 has a lower end adapted to be connected to a water source to allow the water flowing into the passage 13.

A switching assembly 20 is mounted in the main body 10 between the handle 11 and the spray head 12 for controlling the operating type of the spray gun.

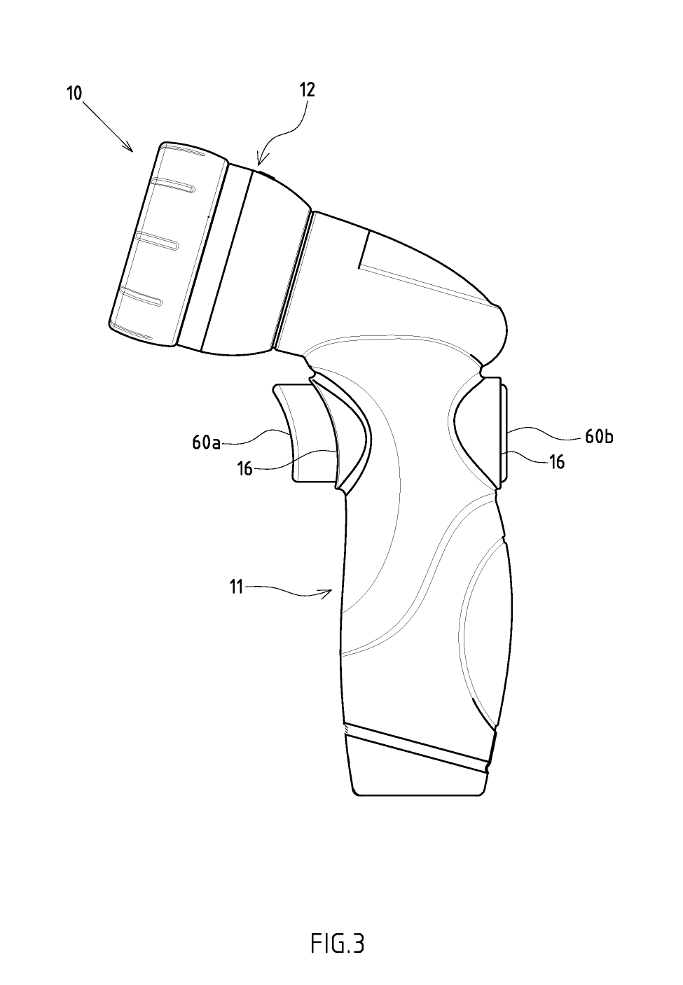

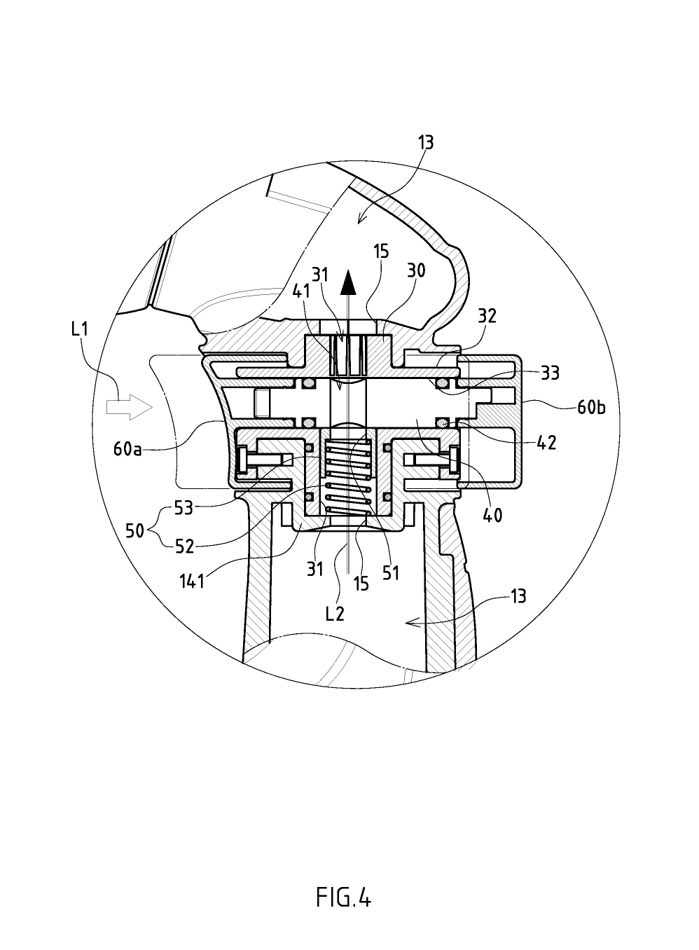

With reference to FIGS. 3 and 4, the switching assembly 20 includes a seat 30 mounted in the main body 10, a shank 40 extending through the seat 30, an outlet set 50 received in the seat 30, a first button 60a and a second button 60b, wherein the first button 60a and the second button 60b are respectively connected two a front end and a rear end of the shank 40.

The seat 30 is partially received in the receiving portion 14 in the handle 11 and inserted into the passage 13 through the opening 15. A through hole 31 is defined in the seat 30 and communicates with the passage 13 in the main body 10. Two tubes 32 respectively extend from the seat 30 and each tube 32 has a tunnel 33 defined therein, wherein the two tunnels 33 linearly correspond to each other and respectively communicate with the through hole 31 in the seat 30.

The shank 40 extends through the seat 30 via the two tunnels 33 and is reciprocally movable relative to the seat 30. The shank 40 has a first through hole 41 diametrically defined therein and selectively communicating with the through hole 31. Two sealing elements 42 are respectively sleeved on two opposite ends of the shank 40 such that an air-tight relation is formed between the shank 40 and the seat 30.

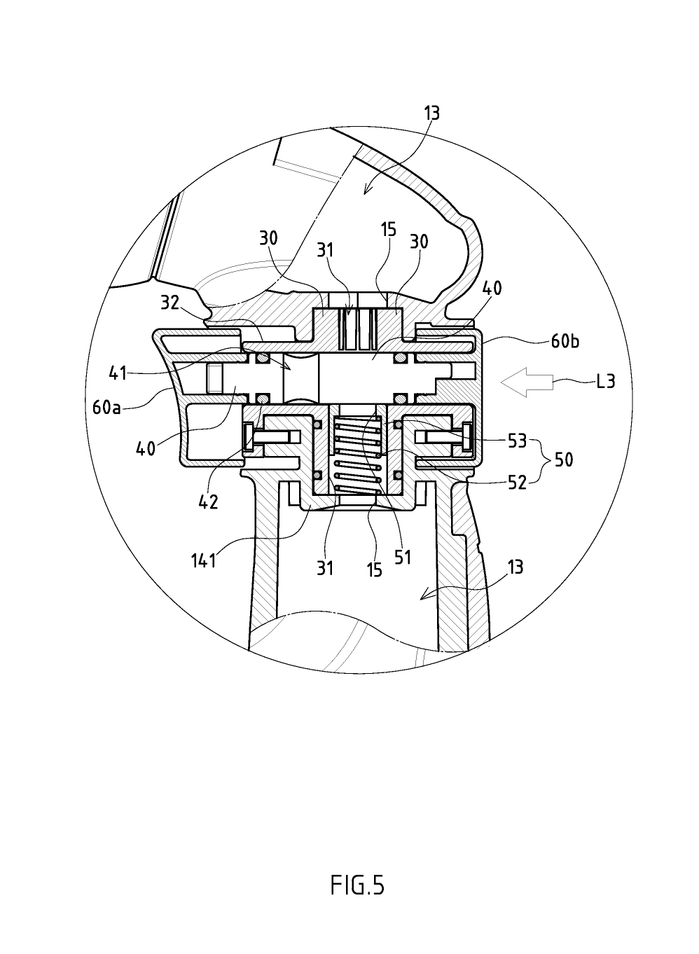

With reference to FIGS. 4 and 5, the handle 11 has a stopper 141 inwardly extending from an inner periphery of a lower portion of the receiving portion 14. The outlet set 50 includes a spring 52 and a tubular element 53 sequentially mounted into the through hole 31 in the seat 30, wherein the spring 52 has two opposite ends respectively abutting against the stopper 141 and the tubular element 53 such that the tubular element 53 securely abuts the shank 40. A second through hole 51 is defined in the tubular element 53 and selectively communicates with the first through hole 41 in the shank 40. In the preferred embodiment of the present invention, the tubular element 53 is made of flexible material, such as rubber, for air tightly abutting against the shank 40.

The first button 60a and the second button 60b are respectively attached to a front end and a rear end of the shank 40 for operator to easily moving the shank 40 relative to the main body 10. The through hole 31, the second through hole 51 and the first through hole 41 sequentially communicate with one another when the shank 40 is backwardly pushed by the first button along the arrow L1 in FIG. 4. Consequently, the water is sprayed out of the spray head 12 along the arrow L2 in FIG. 4 after flowing through the through hole 31, the second through hole 50 and the first through hole 41. The water source is blocked and the spray head 12 stop to spray water when the shank 40 is forwardly pushed by the second button 60b along the arrow L3 in FIG. 5 and the second through hole 51 does not communicate with the first through hole 41. As described above, the first button 60a and the second button 60b alternately extend out of the main body 10 for user to easily operate the shank 40.

With reference to FIGS. 1 and 3, the handle 11 has two curved protrusions 16 extending therefrom and linearly corresponding to each other for supporting the first button 60a and the second button 60b.

By the assemblies described hereinbefore, the user can easily change the conditions of blocked and communicated only by pushing the first button 60a/second button 60b. As a result, the user does not need to continually press the trigger of the conventional spray gun such that the user's palm is not numb after operating the spray gun in accordance with the present invention for a period of time. Consequently, the spray gun in accordance with the present invention is more comfortable and convenient relative to the conventional spray gun in accordance with the prior art.

Although the invention has been explained in relation to its preferred embodiment, it is to be understood that many other possible modifications and variations can be made without departing from the spirit and scope of the invention as hereinafter claimed.

I claim:

1. A spray gun comprising:
a main body including a handle and a spray head mounted to each other, wherein the handle and the spray are hollow structures such that a passage is defined in the main body, a T-shaped receiving portion defined in a top portion of the handle and an opening defined in a bottom of the receiving portion, wherein the opening communicates with the passage, the handle having a lower end adapted to be connected to a water source to allow the water flowing into the passage; and
a switching assembly mounted in the main body between the handle and the spray head for controlling the operating type of the spray gun, the switching assembly comprising:
a seat mounted in the main body and partially received in the receiving portion in the handle, the seat having a through hole defined therein and communicating with the passage in the main body, two tubes respectively extending from the seat and each tube having a tunnel defined therein, wherein the two tunnels linearly correspond to each other and communicate with the through hole in the seat;
a shank extending through the seat via the two tunnels and reciprocally movable relative to the seat, a first through hole diametrically defined in the shank and selectively communicating with the through hole; and
a first button and a second button respectively mounted onto a front end and a rear end of the shank, the first button and the second button alternately extend out of the main body for user to easily controlling the operating type of the spray gun.

2. The spray gun as claimed in claim 1, further comprising an outlet set positioned in the through hole, a second through hole in defined in the outlet set and selectively communicating with the first through hole, the first through hole and the second through hole communicating with each other when the first button is backwardly pushed.

3. The spray gun as claimed in claim 2, wherein the handle has a stopper inwardly extending from an inner periphery of a lower portion of the receiving portion, and the outlet set includes a spring and a flexible tubular element sequentially mounted into the through hole in the seat, the spring has two opposite respectively abutting against the stopper and the tubular element such that the tubular element abuts against the shank.

4. The spray gun as claimed in claim 1, wherein the handle includes two curved protrusions extending therefrom and linearly corresponding to each other for supporting the first button and the second button.

5. The spray gun as claimed in claim 2, wherein the handle includes two curved protrusions extending therefrom and linearly corresponding to each other for supporting the first button and the second button.

6. The spray gun as claimed in claim 3, wherein the handle includes two curved protrusions extending therefrom and linearly corresponding to each other for supporting the first button and the second button.

7. The spray gun as claimed in claim 4, wherein the shank includes two sealing elements respectively sleeved on two opposite ends thereof such that an air-tight relation is formed between the shank and the seat.

8. The spray gun as claimed in claim 5, wherein the shank includes two sealing elements respectively sleeved on two opposite ends thereof such that an air-tight relation is formed between the shank and the seat.

9. The spray gun as claimed in claim 6, wherein the shank includes two sealing elements respectively sleeved on two opposite ends thereof such that an air-tight relation is formed between the shank and the seat.
